(19) United States
(12) Patent Application Publication
(10) Pub. No.: US 2026/0108973 A1
(43) Pub. Date: Apr. 23, 2026

(54) HEAT PROTECTING SHIELD AND ARRANGEMENT IN CONNECTION WITH WELDING TORCH

(71) Applicant: KEMPPI OY, Lahti (FI)

(72) Inventors: Timo TOLVANEN, Lahti (FI); Lauri MÄKI, Lahti (FI)

(21) Appl. No.: 19/487,158

(22) PCT Filed: Jun. 18, 2024
(86) PCT No.: PCT/FI2024/050326

§ 371 Date: Nov. 24, 2025

(30) Foreign Application Priority Data
Jun. 21, 2023 (FI) 20235702

(51) Int. Cl. B23K 9/32

(52) U.S. Cl. CPC B23K 9/321

(57) ABSTRACT

A heat protecting shield (1) for a welding torch (20) comprises a first end (2) comprising a U-shaped groove (3) for receiving, at least partly, the welding torch (20) in such a manner that when the welding torch (20) is received in the U-shaped groove (3), a welding torch tip (21) is provided on one side of the heat protecting shield (1), which is the front side (13), and a welding torch handle (22) is provided on an opposite side of the heat protecting shield (1), which is the back side (14), in relation to the welding torch tip (21). The heat protecting shield (1) further comprises a second end (4) at an opposite end of the heat protecting shield (1) in relation to the first end (2), which second end (4) comprises a connecting portion (5) connecting the branch portions (6) extending on both sides of the groove (3) and a flexible portion (7) provided at least in an area of the connecting portion (5) enabling at least a part of the heat protecting shield (1) to bend in relation to the welding torch.

### FIELD OF THE DISCLOSURE

The present disclosure relates to arc welding, and more particularly to a heat protecting shield for a welding torch and a welding torch.

### BACKGROUND OF THE DISCLOSURE

Welding torches produce a fair amount of heat, and different kinds of burns are the most common injury in connection with welding. While different types of personal protective equipment, such as welding gloves, are available, the protection they provide may not be sufficient in all situations. In addition, the most protective equipment, for instance welding gloves, might not be very convenient for continuous use in challenging welding situations.

### BRIEF DESCRIPTION OF THE DISCLOSURE

An object of the present disclosure is to provide a new heat protecting shield and arrangement in connection with a welding torch.

The object of the disclosure is achieved by heat protecting shield and an arrangement which are characterized by what is stated in the independent claims. Some embodiments of the disclosure are disclosed in the dependent claims.

The disclosure is based on the idea of providing a heat shield connectable to a welding torch, which heat shield has a flexible portion.

An advantage of heat protecting shield and arrangement of the disclosure is that it provides a good protection against heat, while enabling accurate welding even in challenging welding situations.

### BRIEF DESCRIPTION OF THE DRAWINGS

In the following the disclosure will be described in greater detail by means of preferred embodiments with reference to the accompanying drawings, in which

FIG. 1 illustrates schematically a heat protecting shield attached in a welding torch shown in perspective;

FIG. 2 illustrates schematically a heat protecting shield shown in perspective from the front side;

FIG. 3 illustrates schematically a heat protecting shield shown in perspective from the back side; and

FIG. 4 illustrates schematically a spring member seen in perspective.

The figures are provided for illustrating some features of the disclosure only and are not shown to scale. Same reference numbers are used for similar features in different figures and embodiments. Not all similar features are necessarily provided with reference numbers for the sake of clarity.

### DETAILED DESCRIPTION OF THE DISCLOSURE

In this description, terms like vertical, horizontal, top, bottom, lower, upper, and so on have been used to refer to positions and directions, for instance to positions and directions, where the welding torch handle 20 is in a substantially horizontal direction and the heat protecting shield 1 is in a substantially vertical direction.

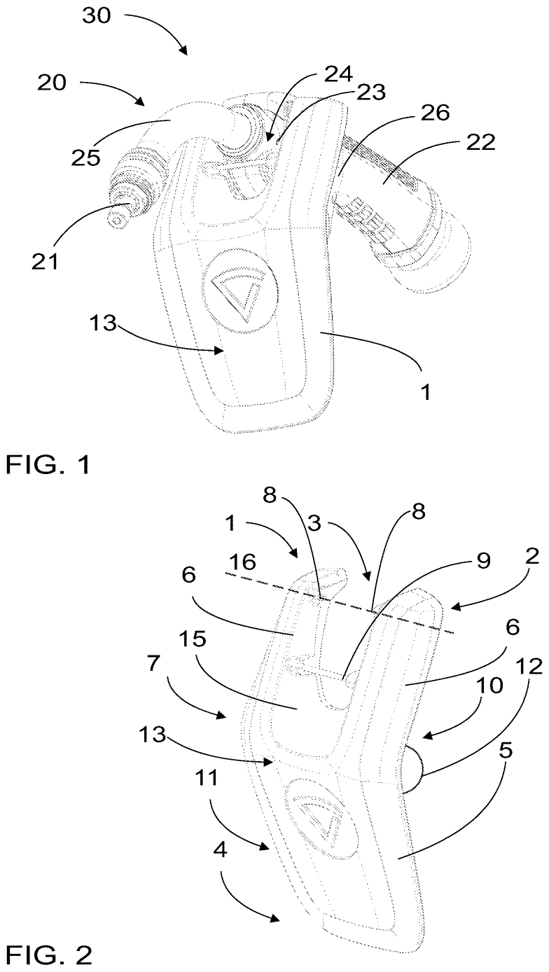

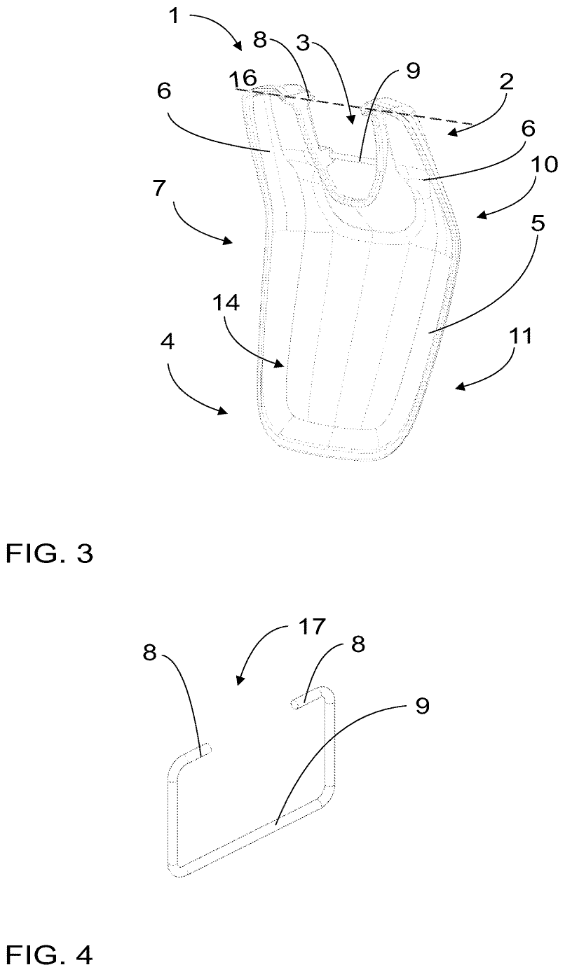

FIG. 1 illustrates schematically a heat protecting shield attached in a welding torch shown in perspective, FIG. 2 illustrates schematically a heat protecting shield shown in perspective from the front side, and FIG. 3 illustrates schematically a heat protecting shield shown in perspective from the back side.

A heat protecting shield 1 for a welding torch 20, such as a heat protecting shield 1 of FIG. 1, 2 or 3, comprises a first end 2, a second end 4, and a flexible portion 7.

The first end 2 comprises a U-shaped groove 3 for receiving, at least partly, the welding torch 20 in such a manner that when the welding torch 20 is received in the U-shaped groove 3, a welding torch tip 21 is provided on one side of the heat protecting shield 1, which is the front side 13, and a welding torch handle 22 is provided on an opposite side of the heat protecting shield 1, which is the back side 14, in relation to the welding torch tip 21. More particularly, the U-shaped groove 3 may open towards the first end 2 and extend from the first end 2 towards the second end 4. In other words, the heat protective shield 1 is configured to receive the welding torch 20 in such a manner that the welding torch 20, for instance the welding torch handle 22 and/or a welding torch neck 25 extend through the groove 3.

The second end 4 is provided at an opposite end of the heat protecting shield 1 in relation to the first end 2. In other words, the second end 4 and the first end 2 provided with the groove 3 are provided at opposite ends of the heat protecting shield 1. The second end 4 comprises a connecting portion 5 connecting branch portions 6 extending on both sides of the groove 3. In other words, the heat protecting shield 1 comprises two branch portions 6 extending to the first end 2 on each side of the groove 3 and a connecting portion 5 extending to the second end 4 and connecting the branch portions 6 between the first end 2 and the second end 4 at the end point of the groove 3.

The flexible portion 7 is provided at least in an area of the connecting portion 5 enabling at least a part of the heat protecting shield 1 to bend in relation to the welding torch 20. According to an embodiment, the flexible portion 7 comprises at least the entire connecting portion 5. According to an embodiment, the flexible portion 7 further comprises the entire branch portions 6. In such embodiments, the entire heat protecting shield 1 is, thus, flexible, in other words bendable. The heat protecting shield 1 or the flexible portion 7 being flexible, or bendable, refers to the heat protecting shield 1 or the flexible portion 7 being bendable by a normal amount of force or pressure, for instance a force or pressure applied by hand by an average person, by an amount of deformation visible for a human eye. According to an embodiment, the deformation is reversible. In other words, the flexible portion 7, and the heat protecting shield 1, return to their original shape, when the force or pressure is no longer applied to the heat protecting shield 1. According to an embodiment, the flexibility, in other words the bendability, of the flexible portion 7 is provided by at least one of the following: the material of the flexible portion 7, the structure of the flexible portion 7, or the way the flexible portion 7 is attached to the welding torch 20. This may be beneficial especially when welding in tight space or otherwise challenging situations. The welder may, for instance, bend the heat protecting shield 1 below their hand or finger to get a better grip or reach a tight spot.

According to an embodiment, the heat protecting shield 1, or at least the flexible portion 7, comprises of silicone material, or silicone rubber, in other words a flexible silicone material. This may be beneficial, as silicone materials are typically flexible, heat insulating, heat resistant and durable. According to an embodiment, the heat protecting shield 1, or at least the flexible portion 7, is comprises leather. Leather is also a sufficiently flexible, heat insulating, heat resistant and durable at least for certain applications.

According to an embodiment, the U-shaped groove may extend from the first end 2 towards the second end 4 a length, which is at least 10 percent of the total distance between the first end 2 and the second end 4. According to an embodiment, the U-shaped groove may extend from the first end 2 towards the second end 4 a length, which is equal to at least a half of a height of the welding torch 20 at the point where it is configured to be received in the groove 3 and measured in the direction parallel to the length of the groove 3.

The U-shaped groove 3 is, thus, configured to receive the welding torch 20 at least partly. In other words, at least a part of the height of the welding torch 20 at the point where it is configured to be received in the groove 3 and measured in the direction parallel to the length of the groove 3 is provided in the groove 3, when the heat protective shield 1 is attached to the welding torch 20. According to an embodiment, at least a half, preferably at least 70 percent, of the height of the welding torch 20 at the point where it is configured to be received in the groove 3 and measured in the direction parallel to the length of the groove 3 is provided in the groove 3, when the heat protective shield 1 is attached to the welding torch 20.

According to an embodiment, each one of the branch portions 6 is provided with a protrusion 8 protruding to the groove 3. Each protrusion 8 may have, at least at a free end, a cross section configured to conform at least partly to a head of a screw 23 provided on a side 24 of the welding torch handle 22. The free end refers to the end of the protrusion 8 not connected to the branch portion 6 but facing towards the middle of the groove 3. Thus, the cross section of at least the free end of the protrusion 8 may be designed to conform at least partly to the head of the screw 23 in the welding torch handle 22. The cross section of the protrusion 8 at the free end conforming at least partly to the head of the screw 23 refers to the free end of the protrusion 8 fitting in a recess in the head of the screw and at least partly conforming to the shape of the recess, or the free end of the protrusion 8 receiving the head of the screw 23 in a recess provided at the free end of the protrusion 8 and conforming at least partly to the shape of the head of the screw. Thereby, the protrusions 8 are configured to attach the heat protecting shield 1 to the welding torch 20 by each one of the protrusions 8 being received in each case one of the heads of the screws 23. In other words, the heat protecting shield 1 is designed to be attached to the welding torch 20 by placing the welding torch 20 in the groove 3 in such a manner that the protrusions 8 provided on the groove 3 side surface of each branch portion 6 engage with heads of the screws 23 provided on opposite sides 24 of the welding torch handle 22. According to an embodiment, the cross section of each protrusion 8, at least at the free end of the protrusion 8, is formed to conform to a head of at least one of: a cross head screw, a slotted head screw, a hex socket screw, a hexalobular internal screw, or a square head screw.

According to an embodiment, the heat protecting shield 1 further comprises a pin member 9 extending between the branch portions 6 and across the groove 3 below the protrusions 8 to further support the heat protecting shield 1 to the welding torch tip 21 or the welding torch handle 22. According to an embodiment, the welding torch handle 22 comprises a groove (not shown), or recess, extending across the width of the welding torch handle 22 on the side of the welding torch handle 22 facing the end of the groove 3 in the heat protecting shield 1, and the pin member 9 is configured to be received in the groove in the welding torch handle 22 in at least one use position of the welding torch 20 with respect to the heat protecting shield 1. A use position of the welding torch 20 refers to a mutual position of the heat protecting shield 1 and the welding torch 20 during normal use of the welding torch 20. According to an embodiment, the pin member 9 is configured to further support the heat protecting shield 1 to the welding torch tip 21 or the welding torch handle 22, when the heat protecting shield 1 is rotated in relation to the welding torch 20 about the rotation axis 16 defined by the protrusions 8.

FIG. 4 illustrates schematically a spring member seen in perspective.

According to an embodiment, the protrusions 8 and the pin member 9 are formed of a continuous spring member 17 extending between the protrusions 8 and along the pin member 9, such as the spring member 17 of FIG. 4. According to an embodiment, the spring member 17 comprises a shape of a cut rectangle, a cut rectangle with rounded corners, such as in FIG. 4, a cut oval, or a cut circle, wherein the cut portion is configured to receive the welding torch handle 22 and to engage with the screws 23 in the welding torch handle 22. In other words, the ends of the spring member 17 are configured to form the protrusions 8, and more particularly the free ends of the protrusions, configured to engage with the screws 23. According to an embodiment, the spring member 17 comprises spring steel, preferably stainless spring steel. According to an embodiment, the spring member 17 may comprise another suitable material, which is heat resistant to welding temperatures, durable and reversibly deformable to a sufficient amount to enable attaching and removing the heat protecting shield 1 from the welding torch 20. According to an embodiment, a part or several parts of the spring member 17 between the protrusions 8 and the pin member 9 may be moulded into the rest of the heat protecting shield 1, such as to the branch portions 6. According to an embodiment, the spring member 17 may be mounted to the rest of the heat protecting shield 1, such as the branch portions 6, in some other manner, such as snap-locking shapes provided in the heat protecting shield 1 to receive the spring member 17, by sewing, by being riveted to the material, by being threaded through the material, or in some other suitable manner.

According to an embodiment, the heat protecting shield 1 comprises a heat insulating material enduring high temperatures, more particularly temperatures related to welding. According to an embodiment, the heat protecting shield 1 may comprise a material having a heat resistance of at least 180 degrees Celsius, preferably at least 200 degrees Celsius, and most preferably at least 250 degrees Celsius. According to an embodiment, the heat protecting shield 1 comprises at least one of silicone rubber and leather.

According to an embodiment, the heat protecting shield 1 comprises a top portion 10 and a bottom portion 11, wherein the top portion comprises at least a part of the branch portions 6 and the bottom portion 11 comprises at least a part of the connecting portion 5, and wherein the bottom portion 11 is provided at an angle 12 with respect to the top portion 10. According to an embodiment, the angle 12 is in the range of 15 to 70 degrees.

According to an embodiment, at least the top portion 10 is provided on the front side 13 of the heat protecting shield 1 and adjacent to the groove 3 a recess 15, which recess 15 has a U-shaped cross section opening towards the front side 13. The recess 15 may be configured to receive a welding torch neck 25, when the heat protecting shield 1 is rotated in relation to the welding torch 20 about a rotation axis 16 defined by the protrusions 8. This may be beneficial especially in more challenging welding positions and tight spaces.

According to an aspect, an arrangement 30 comprises a welding torch 20 and a heat protecting shield 1 according to an embodiment disclosed in this description and/or accompanying claims and/or drawings. In the arrangement 30, the welding torch 20 may be received in the U-shaped groove 3. A welding torch tip 21 may be provided on one side of the heat protecting shield 1, which is the front side 13, and a welding torch handle 22 may be provided on an opposite side of the heat protecting shield 1, which is the back side 14, in relation to the welding torch tip 21.

According to an embodiment, the welding torch 20 may further comprise an additional handle 26 attached to the welding torch handle 22 to better support the welding torch 20 during welding operation. The heat protecting shield 1 may be designed to receive the additional handle 26. Such additional handles are known as such and are not described here in more detail.

1. A heat protecting shield for a welding torch, wherein the heat protecting shield comprises:
a first end comprising a U-shaped groove for receiving, at least partly, the welding torch in such a manner that when the welding torch is received in the U-shaped groove,
a welding torch tip is provided on one side of the heat protecting shield, which is the front side, and a welding torch handle is provided on an opposite side of the heat protecting shield, which is the back side, in relation to the welding torch tip,
a second end at an opposite end of the heat protecting shield in relation to the first end, which second end comprises a connecting portion connecting branch portions extending on both sides of the groove,
a flexible portion provided at least in an area of the connecting portion enabling at least a part of the heat protecting shield to bend in relation to the welding torch.

2. The heat protecting shield according to claim 1, wherein the flexible portion comprises at least the entire connecting portion.

3. The heat protecting shield according to claim 2, wherein the flexible portion further comprises the entire branch portions.

4. The heat protecting shield according to claim 1, wherein the flexibility of the flexible portion is provided by at least one of the following: the material of the flexible portion, the structure of the flexible portion, or the way the flexible portion is attached to the welding torch.

5. The heat protecting shield according to claim 1, wherein each one of the branch portions is provided with a protrusion protruding to the groove, having a cross section configured to conform at least partly to a head of a screw provided on a side of the welding torch handle, and configured to attach the heat protecting shield to the welding torch by each one of the protrusions being received in each case one of the heads of the screws.

6. The heat protecting shield according to claim 5, wherein the cross section of each protrusion is formed to conform to a head of at least one of: a cross head screw, a slotted head screw, a hex socket screw, a hexalobular internal screw, or a square head screw.

7. The heat protecting shield according to claim 1, wherein the heat protecting shield further comprises a pin member extending between the branch portions and across the groove below the protrusions to further support the heat protecting shield to the welding torch tip or the welding torch handle.

8. The heat protecting shield according to claim 7, wherein the protrusions and the pin member are formed of a continuous spring member extending between the protrusions and along the pin member.

9. The heat protecting shield according to claim 1, wherein the heat protecting shield comprising a heat insulating material enduring high temperatures.

10. The heat protecting shield according to claim 9, wherein the heat protecting shield comprises at least one of silicone rubber and leather.

11. The heat protecting shield according to claim 1, wherein the heat protecting shield comprises a top portion and a bottom portion, wherein the top portion comprises at least a part of the branch portions and the bottom portion comprises at least a part of the connecting portion, and wherein the bottom portion is provided at an angle with respect to the top portion.

12. The heat protecting shield according to claim 11, wherein the angle is in the range of 15 to 70 degrees.

13. The heat protecting shield according to claim 11, wherein at least the top portion is provided on the front side of the heat protecting shield and adjacent to the groove a recess, which recess has a U-shaped cross section opening towards the front side configured to receive a welding torch neck, when the heat protecting shield is rotated in relation to the welding torch about a rotation axis defined by the protrusions.

14. An arrangement in connection with a welding torch, wherein the arrangement comprises
a welding torch and
a heat protecting shield according to claim 1, and
wherein the welding torch is received in the U-shaped groove, a welding torch tip is provided on one side of the heat protecting shield, which is the front side, and a welding torch handle is provided on an opposite side of the heat protecting shield, which is the back side, in relation to the welding torch tip.

15. The arrangement according to claim 14, wherein the welding torch further comprises an additional handle attached to the welding torch handle to better support the welding torch during welding operation.
